(19) United States
(12) Patent Application Publication
(10) Pub. No.: US 2003/0166367 A1
(43) Pub. Date: Sep. 4, 2003

(54) Textile construction and method for the production thereof

(76) Inventors: Johann Berger, Alfdorf (DE); Norbert Huber, Bad Sackingen (DE); Jorg Ruschulte, Wehr-Brennet (DE)

Correspondence Address: HARNESS, DICKEY & PIERCE, P.L.C., P.O. BOX 828, BLOOMFIELD HILLS, MI, 48303, US

(21) Appl. No.: 10/397,866

(22) Filed: Mar. 26, 2003

Related U.S. Application Data
(63) Continuation of application No. PCT/EP01/11512, filed on Oct. 5, 2001.

(30) Foreign Application Priority Data
Oct. 5, 2000 (DE) 100 49 395.5-26

(51) Int. Cl. B29D 23/00; B32B 1/08; B29D 22/00

(52) U.S. Cl. 442/76; 428/36.1; 428/373

(57) ABSTRACT

The invention relates to a textile construction for using in passenger restraint systems. Said textile construction is characterised in that it contains plastically deformable filaments which enable the surface of the textile construction to increase when pressure is applied in at least one surface direction. The inventive textile construction is also provided with an especially elastic coating.

The present invention relates to a textile sheet fabric for use in passenger restraint systems and to a method of producing same.

Current air bag systems employ air bags principally harboring the risk of a passenger being catapulted back by the high pressure of the air bag once inflated (rubber ball effect) possibly inflicting serious injury. Hitherto this problem was solved by complicated means in providing vent holes or valves in the side of the air bag facing away from the passenger, or so-called filter fabric having a defined permeability. This results in the air bag collapsing on passenger impact due to the gas therein being exhausted to thus cushion the impact. This has drawbacks, however. For one thing, when using filter fabrics having a defined permeability, fluctuations may arise in the absolute permeability to the possible detriment of the gas exhaust of the air bag on impact and to impact hardness. For another, on collapse of the air bag, combustion residues of the air bag inflator may find their way from the air bag vent holes into the vehicle interior where they may result in injuries.

The invention is based on the objective of providing a textile sheet fabric which avoids, or at least greatly diminishes, the disadvantagees of prior art.

This objective is achieved by a textile sheet fabric as set forth in claim 1.

The invention relates to any kind of textile sheet fabric, i.e. be it knitted, woven, braided, crotcheted or other kind of textile sheet fabric made of yarns or fibers. For the sake of simplicity “fabric” as used in the following is always intended to cover any of these variants.

Nowadays, air bags are quite generally termed passenger restraint means in vehicle safety systems. Known in addition to this is an air belt as a combination of seat belt and air bag. Since the fabric in accordance with the invention is intended for use in both an air bag and air belt, i.e. in all systems having the intention of cushioning passenger impact with a bag or bag-like item, we speak here not of an air bag fabric as such but, quite generally for simplification, of just a fabric.

Because of its structure the fabric in accordance with the invention has many advantages as compared to known air bag fabrics.

Thus, making use of plastic deformable threads, i.e. threads having a remaining stretch capacity in thus becoming longer under load, makes it possible to increase the surface of the fabric in accordance with the invention when subjected to impact (e.g. passenger impact). The threads of the fabric instantly stretch and thus become longer without tearing, however. When an air bag made of a fabric in accordance with the invention experiences the impact of a passenger its volume is increased due to the stretch of the fabric. This results in the pressure in the air bag being reduced, it becoming softer, with a likewise reduction in the fiber diameter (titre reduction). This in turn results in the texture of the fabric opening up, i.e. “microholes” materialize, causing the surface to become correspondingly larger. Structuring the fabric in this way is with no regard to its permeability which is of a major advantage as regards the precision needed in fabrication. The required uniform permeability is achieved by coating the air bag fabric in accordance with the invention. This coating is selected so that continues to maintain the permeability constant in the necessary range even at full stretch (due to the surface increase).

Another advantage of this technique is that in the production phase of the air bag fabric the factor permeability can be more or less ignored, since this is regulated via the coating to be later applied additionally, thus making for a considerable reduction in production costs.

A further advantageous aspect of the air bag fabric in accordance with the invention materializes when employing plastic deformable threads or yarns in at least one thread system enabling it to stretch multistage, when required. The first stage in stretching occurs in the inflation phase in which the yarn stretches to the same degree as yarns currently usual. A further stage in stretching commences on impact of the passenger. Here, the deformable yarn continues to stretch in the scope of the remaining stretch capacity. It is due to this additional (final) stretch that the aforementioned increase in volume occurs.

In still another advantage further embodiment of the invention the coating employed is formulated as a highly elastic film or coating. This has the advantage that the film stretches to the same degree as the final stretch of the fabric which when faced with the film retains the necessary permeability whilst being “sealed” thereby. Using the air bag fabric in accordance with the invention in passenger restraint systems makes for yet a further advantage, namely the time needed to inflate the air bag in a crash situation is now possible shorter than with usual air bag fabrics since no inflation gas can escape during inflation prior to attaining the final shape (the same as in prior art). Accordingly, the inflation time is now shorter than with fabrics employed hitherto. The air bag provided with a fabric in accordance with the invention thus offers faster impact protection than a conventional air bag. This time saving cannot be appreciated enough by the person skilled in the art.

The invention will now be detained with reference to the drawing in which

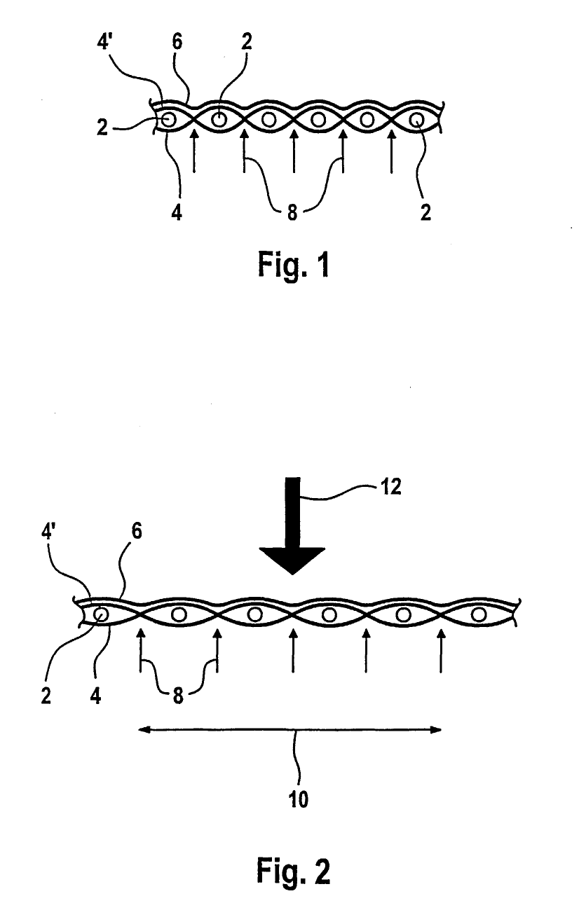

FIG. 1 is a diagrammatic cross sectional view of a fabric in accordance with the invention prior to passenger impact.

FIG. 2 is a detail of a fabric in accordance with the invention following passenger impact.

Referring now to FIG. 1 there is illustrated greatly simplified a cross section through the air bag fabric as viewed in the warp direction in which warp threads 2 are symbolized by small circles in the plane of the drawing corresponding to a section through the warp threads 2. Weft threads 4 and 4′, illustrated here for the sake of simplicity as a plain weave, run in the plane of the drawing from left to right in wrapping the warp threads 2 by known ways and means. Applied to the upper surface (as shown in FIG. 1) of the fabric illustrated in this case is a film 6, affixed thereto, for example, by thermal action or by a usual adhesive. The assignment of weft threads 4 and 4′ and warp threads 2 as shown in FIG. 1 corresponds to the condition of the air bag fabric as leaving the weaving machine following coating. The arrows 8 are intended to depict the air flow through the fabric or the permeability thereof, indicating how the air needs to stream between the threads or intersections of the threads in passing through the fabric.

Referring now to FIG. 2 there is illustrated the same fabric as shown in FIG. 1, but here following impact of the passenger symbolized by the arrow 12 pointing downwards. The reaction to the impact of the passenger in the direction of the arrow 12 causes the air bag fabric to stretch in the direction of the double arrow 10 as shown in FIG. 2, indicating how the fabric has changed by the weft threads 4 and 4′ stretching in thus increasing the spacing between the warp threads 2. Comparing the sections of the air bag fabric as shown in FIG. 1 and FIG. 2 demonstrates the surface increase of the fabric as a result of the plastic deformation or stretch of the weft threads 4 and 4′.

What has not changed, however, in the stretched fabric as compared to its unstretched condition is its permeability as indicated here by the arrows 8. The coating 6 is selected so that even with a maximum increase in the surface it still does not allow a change in the value as specified for the permeability of the air bag fabric.

1. A textile sheet fabric for use in passenger restraint systems, characterized by it comprising plastic deformable threads which when loaded in at least one sheet direction permit an increase in the surface of the fabric provided with a, more particularly, elastic coating of constant permeability.

2. The textile sheet fabric as set forth in claim 1 characterized by it comprising in at least one thread system a yarn having a remaining stretch capacity as compared to standard yarns.
